(19) United States
(12) Patent Application Publication
(10) Pub. No.: US 2012/0140057 A1
(43) Pub. Date: Jun. 7, 2012

(54) Microscope for Measuring Total Reflection Fluorescence

(76) Inventors: Sebastian Borck, Jena (DE); Michael Hilbert, Jena (DE); Michael Gölles, Jena (DE)

(21) Appl. No.: 13/390,181

(22) PCT Filed: Aug. 4, 2010
(86) PCT No.: PCT/EP2010/004778

§ 371 Date: Feb. 13, 2012

(30) Foreign Application Priority Data
Aug. 13, 2009 (DE) 10 2009 037 366.7

(51) Int. Cl. H04N 7/18; G02B 21/02; G02B 21/06

(52) U.S. Cl. 348/79; 359/385; 359/381; 348/E07.085

(57) ABSTRACT

Currently, relatively weak light sources with low light intensities are used in wide-field microscopes. Inevitably, focusing in the pupil plane thereby results in low light intensities in the sample, since the output of the light source is distributed over a very large sample area. However, there are also wide-field technologies requiring very high intensities, for example, photo-activates localization (PAL) microscopy. It is the object of the invention to allow, with little expenditure, the flexible adjustment of the illumination light intensity in the sample. For this purpose, a laser (2) is used for a light source, and a variable lens (10) is arranged in the illumination beam path thus making a variable adjustment of a bean cross section of the illumination light in an intermediate image plane possible, wherein a divergence of the illumination light is identical for different beam cross sections. In this way, the size of the visual field of the microscope can be flexibly adjusted. Thus, the intensity of the laser illumination light in the sample (5) can be varied in a wide range of values.

### RELATED APPLICATIONS

The present application is a U.S. National Stage application of international PCT application number PCT/EP2010/004778 filed on Aug. 4, 2010, which claims the benefit of German application number DE 10 2009 037 366.7 filed on Aug. 13, 2009, the contents of each of which are incorporated by reference in their entirety.

### BACKGROUND OF THE INVENTION

The invention relates to a microscope, having an illuminating beam path, the same having a light source for the purpose of illuminating a sample with illumination light, an objective lens, and a lens which focuses the illumination light in a pupil plane of the objective lens, and having a detection beam path, the same having a detector for receiving fluorescence light from the sample, and particularly a detector with two-dimensional localizing resolution. The invention also relates to a method for the operation of such microscopes.

Such a microscope can be characterized as a wide-field microscope in the narrow sense due to the (dot-shaped) focusing in the pupil plane. In contrast, the illuminating beam path used in scanning microscopes is only either linear in shape (in line scanning), or even collimated (in point scanning).

Microscopy using so-called total internal reflection fluorescence, TIRF, is a special form of fluorescence microscopy. This is disclosed in WO 2006/127692 A2 (for example in FIGS. 9 and 10C thereof), by way of example. FIG. 1 explains the context. The fluorophores F₀ Sample 5 are excited to fluorescence F₁ by an evanescent illuminating field E exclusively in a thin layer behind the boundary surface between the cover glass 16 and the sample 5. The evanescent illuminating field E in the sample 5 is generated by the excitation radiation T inside the cover glass 16 being directed onto the boundary surface between the cover glass and sample at an angle θ>θ_{C}, thereby leading to total reflection. In this case, θ_{C} is the critical angle above which total reflection occurs. Because only the thin layer is excited to fluorescence, it is possible to achieve particularly high axial resolution. The optical axial resolution of a TIRF microscope corresponds to the depth of penetration d of the evanescent field in the sample. The axial resolution is a function of the angle of incidence θ, as:

$$d = \frac{λ}{4 π \sqrt{{n}_{1}^{2} {sin}^{2} θ - {n}_{2}^{2}}} ,$$

wherein λ is the excitation wavelength, n₁ is the refractive index of the cover glass, and n₂ is the refractive index of the sample medium.

Illumination is typically performed as illustrated schematically in FIG. 2, for example, through the objective lens of the microscope 4, in the outer edge region thereof, such that the illuminating light crosses the optical axis of the objective lens 4 after exiting the objective lens 4, at an angle which is greater or equal to the total reflection critical angle θ_{C}. In order to achieve the necessary high angle of incidence in the excitation light T, the microscope objective lens 4 has a high numeric aperture. The resulting fluorescence is collected by the same objective lens 4 and displayed on a camera (not illustrated), for example a charge-coupled device, CCD.

Also, WO 2006/127692 A2 discloses the use of photoswitchable fluorescent dyes (in photo-activated localization microscopy, PALM or PAL-M), for the purpose of increasing microscopic resolution. An extremely low number of fluorphores, the same being randomly distributed, are transformed into an excitable state (activated) by means of very low intensity light at an activation wavelength, then the same are excited to fluorescence in the known manner by means of light at an excitation wavelength. The remaining, unactivated fluorophores cannot be excited to fluorescence by the excitation wavelengths. Due to the random distribution of the fluorophores, the activated and excited fluorophores are typically situated so far away from each other that the intensity distributions of the point source images do not overlap each other, wherein the same result from the fluorescence event and are expanded in a diffraction-limited manner. In PAL microscopy, a plurality of single images, each having a low number of such non-overlapping fluorescence events, is recorded. While the single images are recorded, another group of fluorophores can be activated in such a manner that they replace the previously bleached fluorophores. The intensity distributions of the fluorescence events extend over multiple picture elements (pixels) in the single images due to the diffractive expansion. The origins of the single fluorescence events are localized with subpixel resolution by means of an error compensation utilizing the diffraction expanded intensity distributions.

In modern wide-field microscopy in the narrower sense, in contrast to laser scanning microscopy (and particularly in the case of non-linear fluorescence excitation), only relatively weak light sources with only low light intensities are used. The focusing in the pupil plane in this case necessarily leads to low light intensities in the sample because the energy of the light source is spread over a very large sample area. Low intensities, however, are typically highly desirable for multiple reasons. On the one hand, fluorophores are available which offer a high quantum yield. On the other hand, the radiation exposure in the sample should be kept as low as possible. If observations are made directly through an eyepiece lens, there is also the danger of damage being done to the eyes of the observer if high light intensities occur. Particularly in TIRF microscopy, low illuminating light intensities are desired because high intensities would lead to the saturation of the dyes in the region close to the cover glass, thereby resulting in the dyes located in the deeper regions of the sample having a greater contribution to the image. However, in TIRF microscopy, it is certainly difficult to achieve high intensities in the sample because a large portion of the energy does not arrive in the sample at all due to the total reflection.

However, there are also wide-field techniques that require very high intensities. By way of example, in the case of PAL microscopes, fluorophores which have already been observed must transition to a dark state very quickly to reduce the duration of measurement, which can occur by bleaching. The higher the illuminating light intensity is in this case, the faster the activated fluorophores are bleached.

For these reasons, the invention addresses the problem of improving microscopes and methods of the types described above, such that the illuminating light intensity in the sample can be flexibly adjusted in a simple manner.

### DESCRIPTION OF THE EMBODIMENTS

The problem is addressed by a microscope which has the features of claim 1, and by a method of operation which has the features given in claim 10.

Advantageous embodiments of the invention are given in the independent claims.

According to the invention, the light source is a laser, and a variable lens is arranged in the illuminating beam path, enabling a variable adjustment of a beam cross-section of the illuminating light in an intermediate image plane, wherein the beam spread angle of the illuminating light is identical for different beam cross-sections. In other words, the beam spread angle of the illuminating light, particularly at the point where the same arrives at the sample and in the intermediate image plane, is independent of the beam cross-section in the intermediate image plane. The beam cross-section is the surface incorporated by the illuminating light beam in a plane transverse to the direction of propagation. The identical beam spread angle in the image plane in the various different adjustments can assume any conceivable value, and particularly can be zero, such that the light is collimated.

By arranging a variable lens in an excitation laser beam for the purpose of providing a variable adjustment of the beam cross-section, it is possible to flexibly modify the size of the spatial area of the sample in which a fluorescence excitation is occurring, meaning the visual field of the microscope. Because the transmitted illuminating light output is not influenced by a lens which provides for variable adjustment of the beam cross-section, it is possible to vary the intensity (approximated here as energy per surface area unit) of the laser illuminating light in the sample over a large range of values, by means of changing the beam cross-section in the excitation beam path (and thereby also changing the corresponding beam diameter at the sample). In this way, the same microscope can be used in a simple manner for measurements with both low, and alternatively with high, illuminating light intensity. Different locations in the sample can be illuminated and investigated in this case by means of moving the sample in the plane which is perpendicular to the illuminating beam path and the detection beam path, for example, in the known manner.

The variable lens is preferably arranged outside of the detection beam path. In this way, it is possible to adjust the illuminating beam path cross-section independently of a detection beam path cross-section.

The illuminating beam path can advantageously be designed in such a manner that the illuminating light crosses an optical axis of the objective lens, after exiting the objective lens, at an angle which is greater than or equal to a total reflection angle. In this way, PAL and TIRF microscopes, for example, can be operated with variable illumination intensity.

In a first embodiment, the variable lens has a telescope which can be switched between at least two magnification settings. In this case, the magnification setting of the telescope preferably provides a magnification which is less than one. A configuration offering the possibility of switching to a magnification of less than one enables the same laser output to be directed to a significantly smaller region, therefore making it possible to increase the intensity in the sample at the expense of the field of vision. A telescope having a magnification of 0.5×, by way of example, provides a quadrupling of the light intensity in the sample area.

In a second embodiment, the magnification of the variable lens can be continuously adjusted (as a zoom lens). In this case, the zoom lens can preferably be set to a magnification of less than one. If a zoom lens is used (in place of a telescope), the field of vision and therefore the illumination intensity in the sample can be continuously adjusted.

The restriction of the field of vision by means of shrinking the beam cross-section of the illuminating beam path only introduces minimal interference in techniques like PALM because the observed structures are in the submicrometer range. In order to reduce the disadvantage of the smaller field of vision, the system can be automatically adapted to the smaller field of vision. For this reason, in a further embodiment, the detection beam path advantageously comprises an adjustable, and particularly a magnifying, lens tube which can move between a position in the detection beam path and a position outside of the detection beam path, or comprises a corresponding, adjustable zoom lens. By means of a magnifying lens tube or an accordingly adjustable zoom lens, the entire detector can be illuminated when the field of vision is reduced. As an alternative, the detector image can be cropped to a region of interest, ROI, by software. If only a subregion of the image recorded by the detector, meaning a true subset of the detector pixels, is read out as part of the cropping, this can advantageously lead to a faster frame rate due to the smaller amount of data.

The detection beam path preferably is routed through the same objective lens as the illuminating beam path. This is particularly so in the case of TIRF illumination.

The operation of the microscope according to the invention is preferably carried out in the following steps: the variable lens is set in one of multiple positions; the adjustable lens tube is set in the detection beam path for the purpose of creating an image of a field of vision on the detector, wherein said field of vision corresponds to the adjusted beam cross-section of the illumination light; the illumination light is focused in the pupil plane of the object lens, and fluorescence light from the sample is received by means of the detector.

As an alternative, the operation of the microscope can be carried out in the following steps: the variable lens is set in one of multiple positions; the illumination light is focused in the pupil plane of the objective lens, and the fluorescence light from the sample is received by means of the detector, wherein only a true subset of the pixels of the detector, the same corresponding to a field of vision which is adjusted by means of the beam cross-section of the illuminating light, is recorded as an image. The recording of only a subset of the detector pixels in this case can mean that the detector is read out in its entirety, or it can mean that only a subregion of the detector pixels are recorded in a saved image. As an alternative, this can be only a partial read-out of the detector.

The invention also includes control devices and computer programs which are designed for the purpose of carrying out the method according to the invention.

### BRIEF DESCRIPTION OF THE DRAWINGS

The invention is described in greater detail below with reference to embodiments, wherein:

FIG. 1 shows a scheme of the functionality of TIRF microscopy,

FIG. 2 shows an option for illumination in TIRF according to the prior art, in a schematic illustration,

FIG. 3 shows a schematic illustration of a microscope according to the invention,

FIG. 4 shows a second microscope having a zoom lens,

FIG. 5 shows a third microscope for TIRF illumination,

FIG. 6 shows a result of a cropping procedure on the detector image for the purpose of compensating for a reduced field of vision, and

FIG. 7 shows recorded images using a magnifying lens tube for the purpose of compensating for a reduced field of vision.

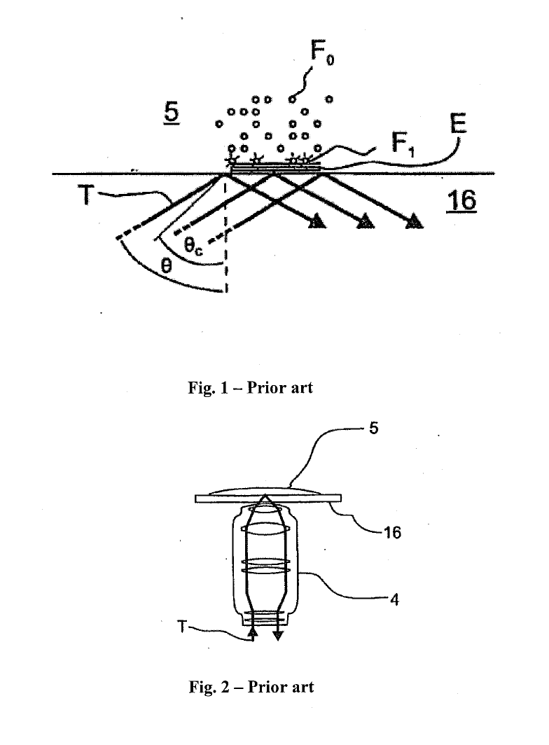

### DETAILED DESCRIPTION OF THE DRAWINGS

In all of the figures, the same components are indicated using the same reference numbers.

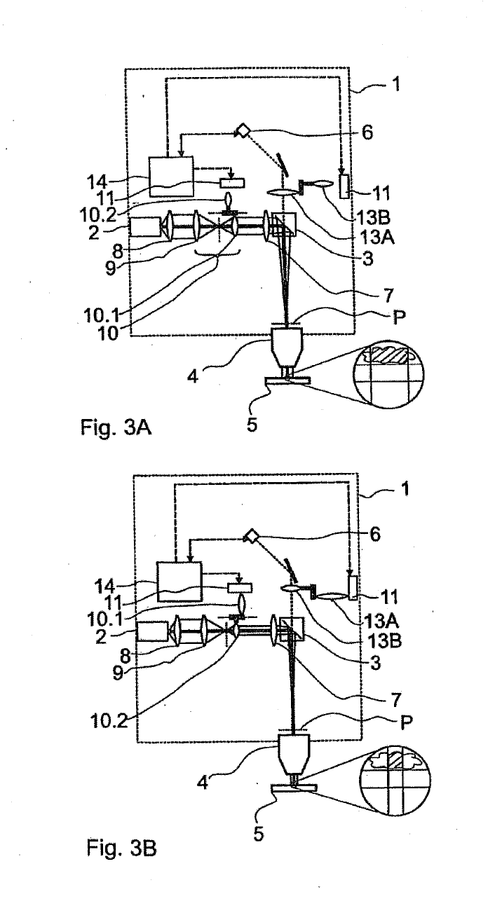

FIG. 3 shows a microscope 1, having an illuminating beam path, wherein a light source 2, a beam splitter 3, and a microscope objective lens 4, among other things, are arranged in said illuminating beam path for the purpose of illuminating a sample 5 with illumination light of the light source 2. The light source 2 is a laser which is suitable for exciting a certain fluorophore location having green fluorescent protein, GFP. The beam splitter 3 couples out a detection beam path which is routed from the sample 5 through the same objective lens 4 to a detector 6. The beam splitter 3 can be designed as a dichroic color splitter which separates the excitation wavelengths of the illumination light in the light coming from the sample 5 from the fluorescence wavelengths of the sample 5. The reflected or scattered fraction of the excitation light is routed to the light source 2, and the fluorescence fraction is routed to the detector 6. The detector 6 is, by way of example, a two-dimensional CCD with localizing resolution.

An optical cable which is not shown is arranged downstream of the laser 2 in the illuminating beam path, and a collimating lens 8 is arranged downstream of the optical cable. In alternative embodiments with no optical cable (not illustrated), the collimating lens 8 can optionally be excluded from the configuration. A variable telescope 10 is arranged downstream of the collimating lens 8 as a means for the variable adjustment of the beam cross-section of the illumination light, wherein an intermediate image plane (not shown) is generated by means of a first lens 9 and a second lens 10.1 deployed for infinite imaging. The telescope is variable insofar as a third lens 10.2, in place of the second lens 10.1, can be moved by means of a drive 11, for example by pivoting. At any given point in time, only one of the lenses 10.1/10.2 can be found in the illuminating beam path. The third lens 10.1 has a smaller focal length than the second lens 10.2. The lenses 10.1, 10.2 in this case are arranged in such a manner and can move in such a manner that the focal planes on the side thereof closer to the illumination source are coincident with the focal plane of the first lens 9, said focal plane being closer to the sample, when the respective lens 10.1/10.2 is pivoted into place. The telescope has, for example with the second lens 10.1 as illustrated, a magnification of 0.9×, but has a magnification of 0.5× with the third lens 10.2. As an alternative, the telescope can have a magnification of 1× or more with the second lens 10.1.

An illumination-side lens tube 7 (illumination lens tube) is arranged in the same section of the beam paths (between the beam splitter 3 and the objective lens 4) and focuses the illuminating beam path as a dot in the pupil plane P of the objective lens 4, or at least in the proximity of the pupil plane P. In this way, the illumination light from the microscope objective lens 4 is cast onto the sample 5 as a collimated bundle. The points of the sample which lie in the sample-side focal plane of the objective lens 4 are imaged via a lens tube 13A/13B on the detector 6 (wide-field microscope). In the case of the wide-field system, the system is not confocal.

The beam spread angle of the illumination light upon entering into the illumination lens tube 7 is not dependent on the magnification setting of the telescope 10.

The lens tubes 13A and 13B can move into the detection beam path by means of a drive 11, for example by pivoting. The second lens tube 13B, in contrast to the first lens tube 13A, provides a stronger magnification of the image on the detector 6. The focal length of the second lens tube 13B is selected such that the field of vision of the microscope with the third telescope lens 10.2 (a smaller field of vision than with the second telescope lens 10.1) is almost entirely imaged on the detector 6 if the second lens tube 13B is in the detection beam path. Accordingly, the focal length of the first lens tube 13A is selected such that the larger field of vision of the microscope with the second telescope lens 10.1 is imaged on the detector 6 if the first lens tube 13B is in the detection beam path.

The control device 14 can adjust the magnification of the telescope 10 and the detection lens tubes 13A/13B via the drive 11. By means of switching between the second lens 10.1 and the third lens 10.2, the beam cross-section of the illuminating beam path can be modified. This results in a variation of the illuminated region of the sample 5, and therefore a variation in the illumination intensity in the sample 5. In addition, the control device 14 can read out the full array of pixels in the detector 6, or can read out only a true subset thereof, and output the same for further processing via an interface (not illustrated).

In FIG. 3A, the second lens 10.1 of the telescope 10 is pivoted into the illuminating beam path. In FIG. 3B, the third lens 10.2 of the telescope 10 is instead pivoted into the illuminating beam path. It can be recognized that the beam cross-section in the illuminating beam path, and the beam diameter in the sample 5, are larger in a configuration using the second lens 10.1 than in a configuration using the third lens 10.2. As such, the field of vision of the microscope 1 is larger in the former case than in the latter (indicated by a view of an enlarged section of the sample 5). The illuminating light intensity in the sample 5 is higher in the latter case than in the former case.

By way of example, the setting of the smaller field of vision is prespecified by a user to the control device 14 (see FIG. 3B). Next, the control device 14 can, by way of example, automatically move the second detection lens tube 13B, the same corresponding to the smaller field of vision, into the detection beam path. Accordingly, the control device 14 can, by way of example, automatically move the first detection lens tube 13A, the same corresponding to the larger field of vision, into the detection beam path. At any given time, there is only one detection lens tube 13A/13B in the detection beam path.

In alternative embodiments (not illustrated), the entire telescope 10 (for example consisting of the first lens 9 and the second lens 10.1) can be automatically swapped out for another telescope having another magnification. Three or more telescopes can also be automatically swapped out for each other.

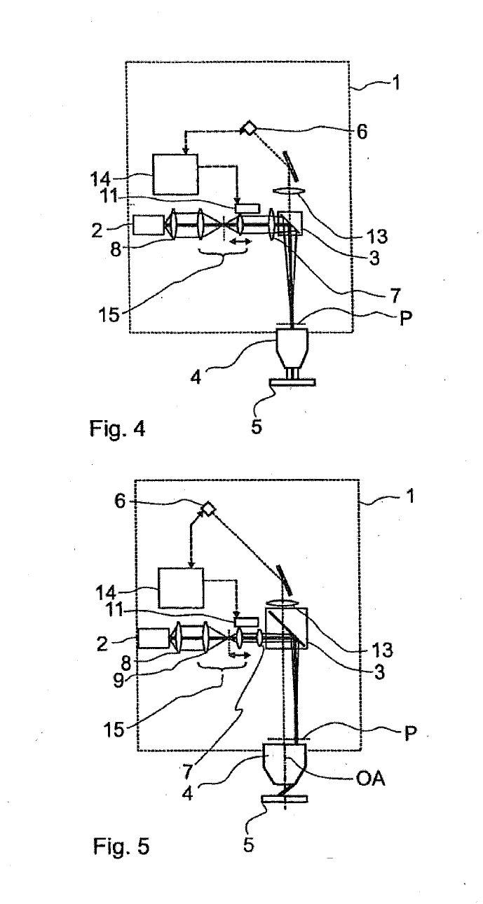

The microscope 1 shown in FIG. 4 is largely identical to the microscope 1 in FIG. 3. However, instead of a telescope 10, a zoom lens 15 is arranged in the illuminating beam path, wherein said zoom lens 15 can be variably adjusted with respect to its imaging scale. It is particularly possible to set magnifications which are less than one. This microscope 1 also enables the modification of the beam cross-section in the illuminating beam path, and therefore of the field of vision. The intensity adjustment which can be achieved in this manner can be regulated in a stepless manner by means of a zoom lens. The beam spread angle of the illumination light upon entering the illumination lens tube 7 does not depend on the magnification setting of the zoom lens 15.

The modification of the field of vision can be automatically compensated in the detection beam path. This can be performed by the control unit 14 processing only a true subset of the pixels of the detector 6, in, for example, the case of a magnification of less than one, through the zoom lens 15, wherein this subset corresponds to the resulting, smaller field of vision. The control device 14 preferably reads out only this subregion of pixels from the detector, in order to minimize the amount of data being transmitted. This enables higher image refresh rates in the recording of the reduced field of vision compared to the

recording of the regular field of vision (zoom lens 15 magnification of one). As an alternative to a detection lens tube 13 with a fixed focal length, a further configuration can include an adjustable detection lens tube 13A/13B as in FIG. 3.

FIG. 5 shows the microscope 1 in FIG. 4 in a TIRF configuration, wherein the illuminating beam path is designed in such a manner that the illumination light crosses the optical axis OA of the objective lens 4 after leaving the objective lens, at an angle which is greater than or equal to a total reflection angle.

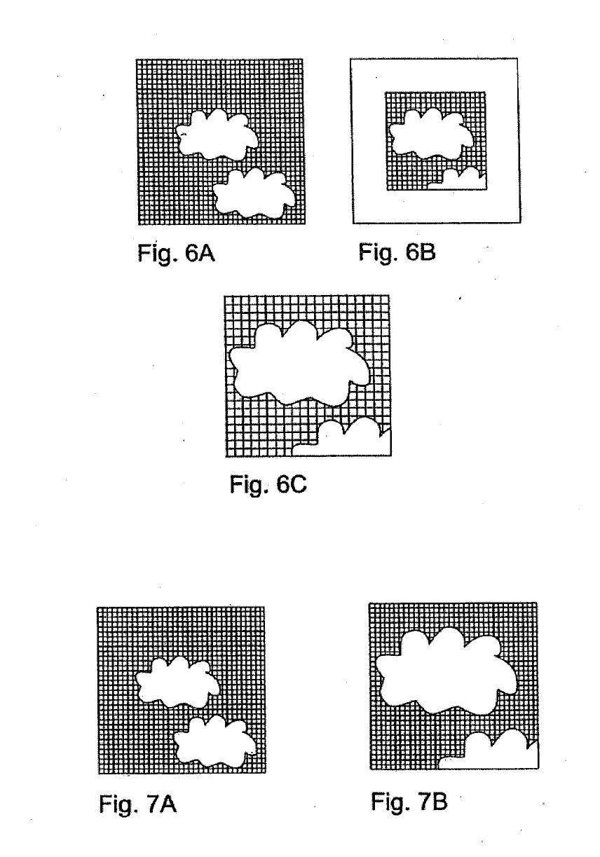

FIG. 6 shows the selection of an interesting region by means of cropping the detector image (the magnifying lens tube 13B is not present, or is not used). FIG. 6A shows the detector pixels of a regular exposure with a large field of view (wherein the second lens 10.1 in the illuminating beam path, and/or the zoom lens 15, is/are set to a magnification of 1:1). FIG. 6B shows the detector pixels of an exposure with the reduced, field of vision (wherein the third lens 10.2 in the illuminating beam path, and/or the zoom lens 15, is/are set to a magnification of less than one). The true subset of the detector pixels can be translated, for example, to the image size of the complete detector. In FIG. 6C, it can be recognized that the region of interest is recorded with the same resolution as in the regular image (FIG. 6A).

FIG. 7 shows the compensation of the reduced field of vision in the area of a region of interest by means of enlargement of the image scale of the detection beam path by means of a magnifying lens tube 13B. FIG. 7A shows (as in FIG. 6A) the detector pixels of a regular exposure with a large field of vision. FIG. 7B shows the detector pixels of an exposure with a reduced field of vision (wherein the third lens 10.2 in the illuminating beam path, and/or the zoom lens 15, is/are set to a magnification of less than one) by means of a magnifying lens tube 13B. It can be recognized that the region of interest has been recorded with higher resolution than in the regular image (FIG. 7A).

### LIST OF REFERENCE NUMBERS

1 Microscope
2 Light source
3 Beam splitter
4 Microscope objective lens
5 Sample
6 Detector
7 Illumination lens tube
8 Collimating lens
9 First lens
10 Variable telescope
10.1 Second lens
10.2 Third lens
11 Drive
12 Eyepiece
13 A/B Detection lens tube
14 Control device
15 Zoom lens
16 Cover glass
θ Angle of incidence
θ_{C} Total reflection critical angle
T Illuminating light
E Evanescent field
F_{0/1} Fluorophore
OA Optical axis
P Pupil plane

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A microscope having an illuminating beam path, wherein for the purpose of illuminating a sample with illumination light, said microscope comprises a light source, an objective lens, and a lens which focuses the illumination light in a pupil plane of the objective lens, and having a detection beam path which includes a detector for receiving fluorescence light of the sample wherein said light source is a laser, and further comprising a variable lens arranged in the illuminating beam path thereby enabling a variable adjustment of a beam cross-section of the illumination light in an intermediate image plane, wherein a beam spread angle of the illumination light is identical for different beam cross-sections.

2. A microscope according to claim 1, wherein the variable lens for adjusting the beam cross-section is arranged outside of the detection beam path.

3. A microscope according to claim 1, wherein the illuminating beam path is designed in such a manner that the illumination light crosses, at an angle which is greater than or equal to a total reflection angle, an optical axis of the objective lens after exiting the objective lens.

4. A microscope according to claim 1, wherein the variable lens comprises a telescope which can be switched between at least two magnification settings.

5. A microscope according to claim 4, wherein a magnification setting of the telescope comprises a magnification of less than one.

6. A microscope according to claim 1, wherein the magnification of the variable lens can be adjusted continuously.

7. A microscope according to claim 6, wherein the continuously adjustable lens can be set to a magnification of less than one.

8. A microscope according to one of the previous claims, wherein the detection beam path comprises an adjustable lens tube which can move between a position in the detection beam path and a position outside of the detection beam path, or the detection beam path comprises an accordingly adjustable zoom lens.

9. A microscope according to claim 1, wherein the detection beam path is routed through the same objective lens as the illuminating beam path.

10. A method for the operation of a microscope according to claim 1, comprising the following steps:
setting the variable lens in one of multiple positions,
setting the adjustable lens tube in the detection beam path for the purpose of imaging a field of vision onto the detector, wherein said field of vision corresponds to the set cross-section of the illumination light,
focusing the illumination light in the pupil plane of the objective lens, and
recording the fluorescence light from the sample by means of the detector.

11. A method for the operation of a microscope according to claim 1 comprising the following steps:
setting the variable lens in one of multiple positions,
focusing the illumination light in the pupil plane of the objective lens, and
recording the fluorescence light from the sample by means of the detector, wherein only a true subset of the pixels of the detector, said subset corresponding to a field of vision which is adjusted by means of the beam cross-section of the illumination light, is recorded as an image.

12. A control device set up for the purpose of carrying out a method according to claim 10 or 11.

13. A microscope having the control device according to claim 12.
